(19) United States
(12) Patent Application Publication
(10) Pub. No.: US 2003/0134257 A1
(43) Pub. Date: Jul. 17, 2003

(54) Interactive learning apparatus

(76) Inventors: Ahmed Morsy, Sammamish, WA (US); Ahmad Abdulkader, (US)

Correspondence Address: AHMED MORSY, 524 237th Ave SE, Sammamish, WA, 98074, US

(21) Appl. No.: 10/047,641

(22) Filed: Jan. 15, 2002

(51) Int. Cl. G09B 5/00

(52) U.S. Cl. 434/169; 434/362

(57) ABSTRACT

The present invention comprises an interactive learning apparatus employing a closed educational loop that encompasses obtaining written and spoken responses characteristic to the user. The user's characteristic response is recognized via handwriting and speech recognition techniques and educational feedback is communicated to the user. The invention also comprises means for allowing an observer or instructor to monitor or influence the interactivity between the disclosed learning apparatus and the user in retrospect or directly via employing memory means and various networking schemes.

### BACKGROUND OF THE INVENTION

1. Field of the Invention

This invention relates generally to interactive learning devices and toys, and more particularly to an interactive learning apparatus that employs a closed educational loop.

2. Description of Prior Art

Educational toys have become very popular with children in recent years, particularly for learning the alphabets, numbers, and spelling of common words. Interactivity of toys has proven effective in increasing the level of entertainment for children so that they will not get bored with the toy quickly. Interactivity is, thus, very useful for educational toys to increase the attention span of the child and, hence, improve the educational value of the toy. Interactive educational toys can generally be classified as either stand-alone or computer-based (a personal computer is necessary to carry out certain parts of the toy tasks).

For example, U.S. Pat. No. 4,078,316 discloses a conversational toy that employs a plurality of coextensive multipurpose audio tracks on magnetic storage medium for providing multiple choice answers, YES/NO type answers, or TRUE/FALSE type answers.

U.S. Pat. No. 5,813,861 discloses a talking phonics interactive learning device with voice synthesis circuitry and keys in the form of raised letters.

U.S. Pat. No. 5,851,119 discloses an interactive story book with a plurality of speech phrases that may be associated with predetermined characters on predetermined pages of the story book.

U.S. Pat. No. 6,264,523 discloses a communication system for a talking doll using infra-red signals and manually operable signal initiation switches.

U.S. Pat. No. 6,159,101 discloses an interactive toy product having articulated limbs with sensors to control the operation of the toy.

U.S. Pat. No. 6,238,262 discloses an interactive puppet having a sound producing means that can be activated in synchronization with a sound track of a video program so that the puppet appears to interact audibly and animatedly with the video program.

U.S. Pat. No. 6,190,174 discloses an electronic story board with a plurality of figures employed by the user to tell a story using synthesized speech.

U.S. Pat. No. 5,944,533 discloses an interactive educational toy in the form of a stuffed animal with a plurality of indicia that the child could press activating a logic circuit containing preprogrammed instruction modalities and play methods communicated using a variety of fun speech patterns so that the toy appears to talk to the child.

U.S. Pat. No. 5,209,695 discloses an apparatus for controlling a toy robot by sound commands using a control system that controls the robot in accordance with the number of space-separated words in the received sound command.

U.S. Pat. No. 5,899,972 discloses a technique for improving voice recognition in low cost speech interactive devices by employing an affirmative/negative discrimination unit.

U.S. Pat. No. 6,160,986 discloses an interactive toy including a speech recognition unit and an interactive content controller employing the information relating to the user's preferences stored in a storage unit and also employing the speech recognition output for providing interactive audio content based on previously stored user's preference.

U.S. Pat. No. 6,108,515 discloses an interactive conversational apparatus with data storage tracks. Interactive conversational content and control code information are stored on tracks in a time sequence for providing pathways through the tracks dependent upon various user responses. User input means may comprise switches.

U.S. Pat. No. 6,111,976 discloses a system and method for handwriting character recognition and qualification using a personal computer. The method is based on comparing the strokes of the user-constructed character to strokes of candidate pre-stored letter templates for the purpose of assessing the quality of the user's writing. The system focuses on students with learning disabilities.

From the above references, it is clear that the prior art includes patents concerned with either creating an “apparent” interaction with the user or concerned with creating responsiveness from the toy to an expected user's input.

If we observe the most common children learning process we realize that it is comprised of a fully closed loop. In the case of learning from a parent or a teacher, this closed educational loop starts by the parent giving the child certain information followed by questions or requests. The parent then receives a response from the child that is characteristic to the child's abilities, evaluates the response based on prior knowledge, then issues certain educational comments back to the child. In most cases, the response from the child may comprise a written response, a spoken response, or both. In the aforementioned setup, the parent or the teacher is also able to monitor the response of the child in real time or in retrospect if both the instructions and the responses were recorded. Clearly, none of the patents disclosed in the prior art is concerned with providing an interactive educational toy that employs a fully closed educational loop that encompasses a child's characteristic feedback response as part of said fully closed educational loop. These disadvantages of the prior art are overcome by the present invention.

### SUMMARY OF THE INVENTION

Accordingly, it is an object of the present invention to overcome the aforementioned limitations in the prior art.

It is an object of the present invention to implement an interactive educational toy with a closed educational loop.

It is a further object of the present invention to employ obtaining a response characteristic to the child using the toy as part of the closed educational loop.

It is still another object of the present invention to employ the interactive closed educational loop for teaching writing and pronunciation of letters, numbers, and words.

It is a further object of the present invention to employ the interactive closed educational loop toy for teaching children arithmetic.

It is still a further object of the present invention to employ a playback memory to allow an observer to monitor the interactivity between the toy and the user in retrospect.

It is also an object of the present invention to employ a wired or wireless networking means to allow an observer to monitor the interactivity between the toy and the user in real time or in retrospect.

It is also an object of the present invention to employ a wired or wireless networking means to allow an instructor to monitor and influence the interactivity between the toy and the user.

There is thus provided in accordance with the preferred embodiment of the present invention an interactive learning apparatus utilizing a closed educational loop employing provision of information and instructions from the apparatus to the user. The apparatus also employs obtaining a response from the user characteristic to the abilities of the user, processing the characteristic response of the user, and issuing educational feedback to the user.

Further, in accordance with the preferred embodiment of the present invention the characteristic response from the user may include a handwritten response, a spoken response, or a combination of both.

Still further, in accordance with the preferred embodiment of the present invention the information and instructions provided by the apparatus includes letters, numbers, symbols, and words, in a written or spoken format, or a combination of both.

Additionally, in accordance with the preferred embodiment of the present invention the information and instructions are provided by the apparatus via one or more of the following or a combination of one or more of the following: a mechanical display, an electronic display, a speaker, a headset speaker.

Moreover, in accordance with the preferred embodiment of the present invention the processing of the characteristic human response includes non-template-based handwriting recognition techniques, speech recognition techniques, or a combination of both.

Further, in accordance with the preferred embodiment of the present invention the characteristic response is obtained via one or more of the following: an electronic writing tablet, a microphone, a tactile button.

Further, in accordance with the preferred embodiment of the present invention an observer is enabled to monitor the interaction between the apparatus and the user via a playback capability employing a playback memory module.

Still further, in accordance with the preferred embodiment of the present invention an observer is enabled to monitor the interaction between the apparatus and the user in real time or in retrospect via an internetworking capability and a storage memory module.

In addition, in accordance with the preferred embodiment of the present invention an observer is enabled to monitor and influence the interaction between the apparatus and the user in real time via an internetworking capability to guide the educational and interactivity process using wired or wireless networking schemes.

### BRIEF DESCRIPTION OF THE DRAWINGS

FIG. 1 presents a block diagram of a basic apparatus in accordance with a preferred embodiment of the present invention.

FIG. 2 is a diagrammatic representation of a closed educational loop.

FIG. 3 is a block diagram of an apparatus in accordance with a preferred embodiment of the present invention indicating an observer monitoring, in retrospect, the interactivity between the apparatus and a user via playback memory capability.

FIG. 4 is a block diagram of an apparatus in accordance with a preferred embodiment of the present invention indicating an observer or an instructor monitoring or influencing the interactivity between the apparatus and the user via a wired network.

FIG. 5 is a block diagram of an apparatus in accordance with a preferred embodiment of the present invention indicating an observer or an instructor monitoring or influencing the interactivity between the apparatus and the user via a wireless network.

FIG. 6 is a flow chart representing an example of employing a closed educational loop apparatus in accordance with a preferred embodiment of the present invention for teaching the writing of an alphabet character.

FIG. 7 is a flow chart representing an example of employing a closed educational loop apparatus in accordance with a preferred embodiment of the present invention for teaching the spelling and pronunciation of a common word via utilizing speech recognition.

FIG. 8 is a flow chart of employing a closed educational loop apparatus in accordance with a preferred embodiment of the present invention for teaching proper pronunciation of words and the concept of rhyming words via utilizing speech synthesis and recognition.

FIG. 9 is a flow chart representing an example of employing a closed educational loop apparatus in accordance with a preferred embodiment of the present invention for teaching simple arithmetic using handwriting or speech recognition.

FIG. 10 is a flow chart representing an example of employing a closed educational loop apparatus in accordance with a preferred embodiment of the present invention for obtaining and improving multi-lingual skills.

### DETAILED DESCRIPTION OF THE INVENTION

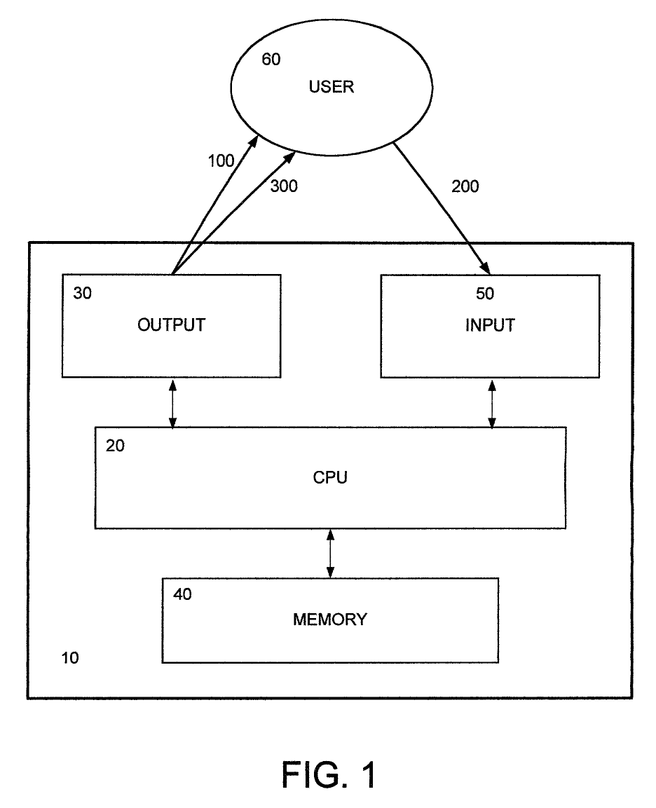

Referring to FIG. 1, a closed educational loop apparatus 10 consists essentially of a CPU 20 which connects to a memory module 40 to obtain operational code. Memory 40 can be completely contained or detachable. Based on a program code that is pre-stored in memory 40, the CPU 20 generates information and instructions 100 and outputs these to a user 60 via an output module 30. The user responds by providing a characteristic human response 200 which is input into the apparatus 10 via an input module 50 and processed directly by CPU 20 or stored with the facilitation of the CPU 20 in memory 40 and then processed by CPU 20. As a result of said processing and based on some quantities that may be pre-stored in memory 40 the CPU 20 outputs educational comments 300 via the output module 30. These educational comments 300 may comprise further information or instructions and the whole process may then repeat. Memory 40 may also serve as playback memory, which is used to record all the transactions between the user and the apparatus for later review by an observer (observer not shown). In another preferred embodiment playback memory may be separate from memory 40.

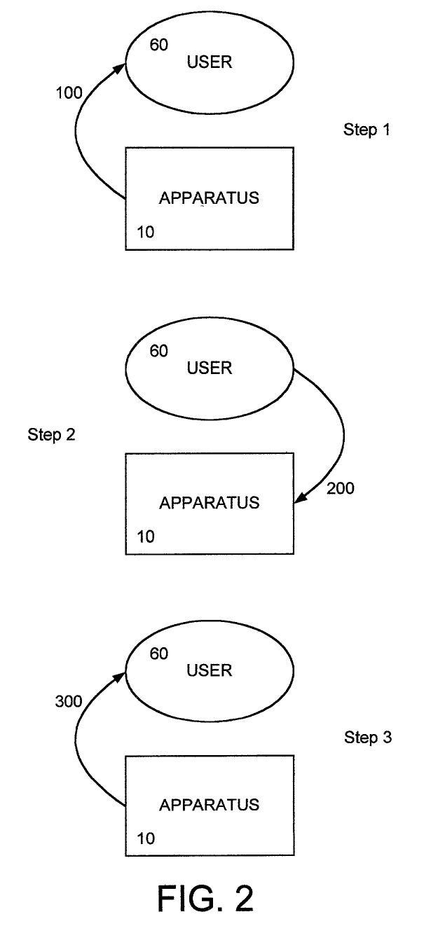

FIG. 2 provides a conceptual representation of a closed educational loop process. For example, the learning apparatus (educational toy) 10 is shown to output information and instructions 100 to a user (child) 60. The user 60 then responds by providing a characteristic human response 200 to the toy 10. After the toy processes the child's response and based on prior stored knowledge it issues educational comments 300 to the user 60. The educational comments 300 may encompass further information or instructions and the whole process may repeat.

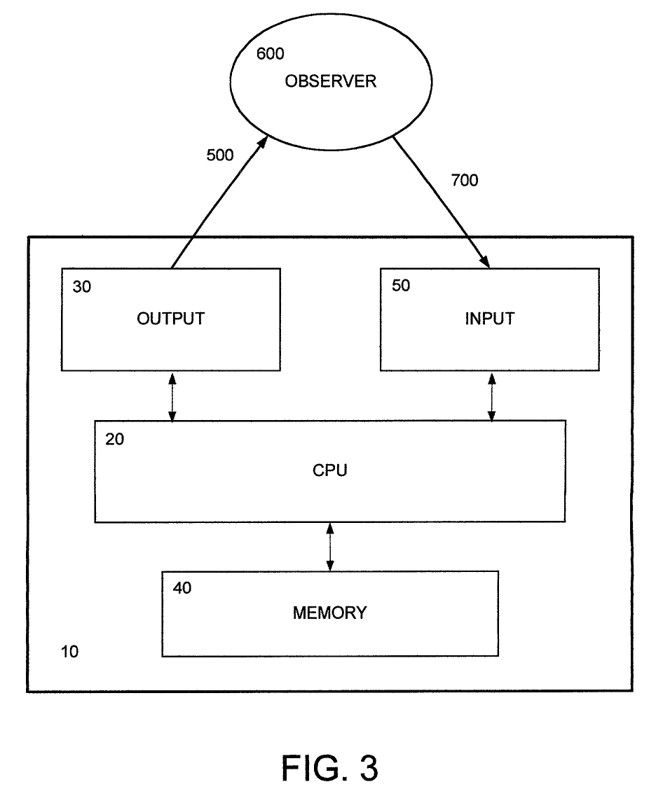

FIG. 3 shows the closed educational loop apparatus depicted in FIG. 1 connected being used by an observer 600 who issues commands 700 to control apparatus 10 to serve the monitoring process. Apparatus 10 responds by output 500 to observer 600. Memory 40 is used here as playback memory but in another preferred embodiment a separate playback memory module may be used.

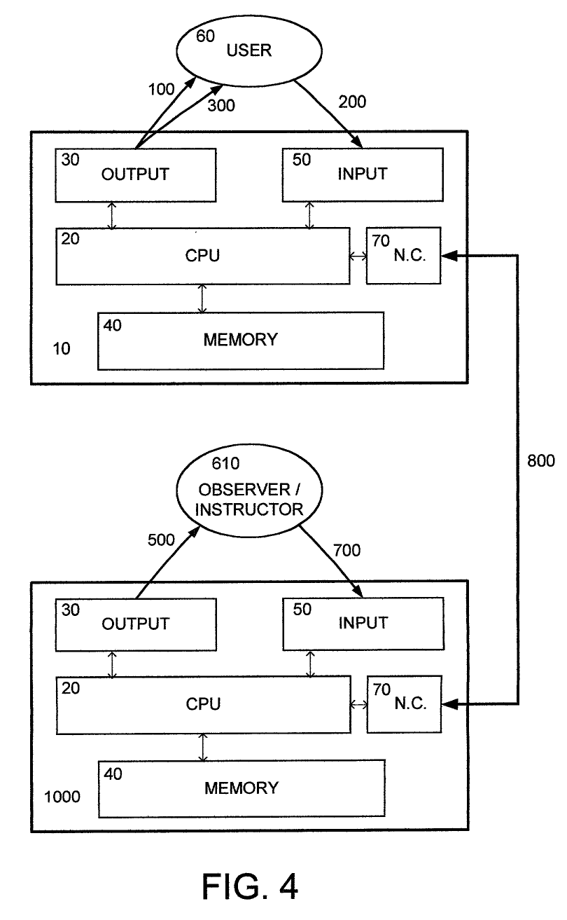

FIG. 4 shows the closed educational loop apparatus depicted in FIG. 1 used by user 60 connected to a similar unit 1000 used by an observer or instructor 610 via network cards 70 and a wired network connection 800. Observer 610 may monitor the transactions between the main unit 10 and its user 60 either in real time or in retrospect. In another preferred embodiment the monitoring unit 1000 may differ in capabilities from main unit 10. Still, in another preferred embodiment unit 1000 may monitor or control multiple other main units 10.

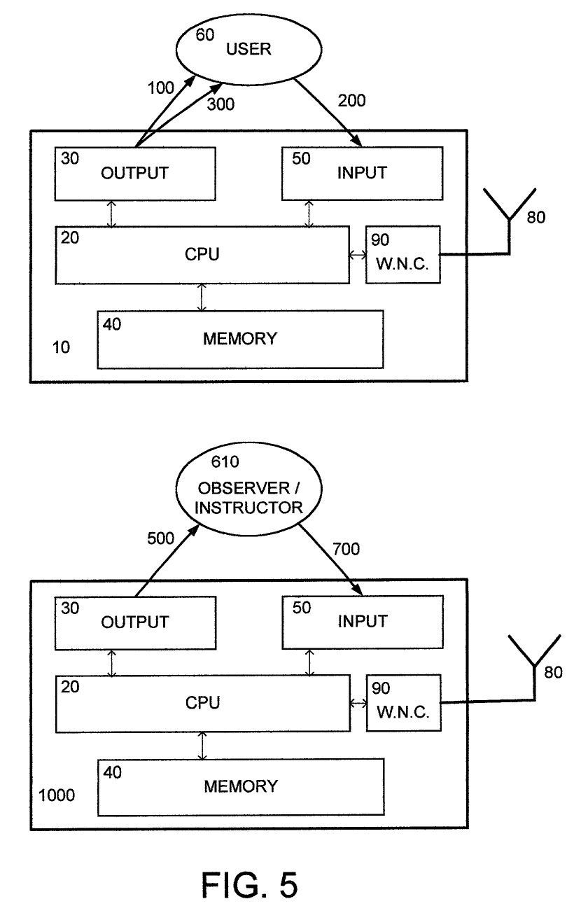

FIG. 5 presents a networking scheme similar to that depicted in FIG. 4 except that the wired network connection comprised of connection 800 and network cards 70 is replaced by a wireless network connection comprised of wireless network cards 90 and antennas 80.

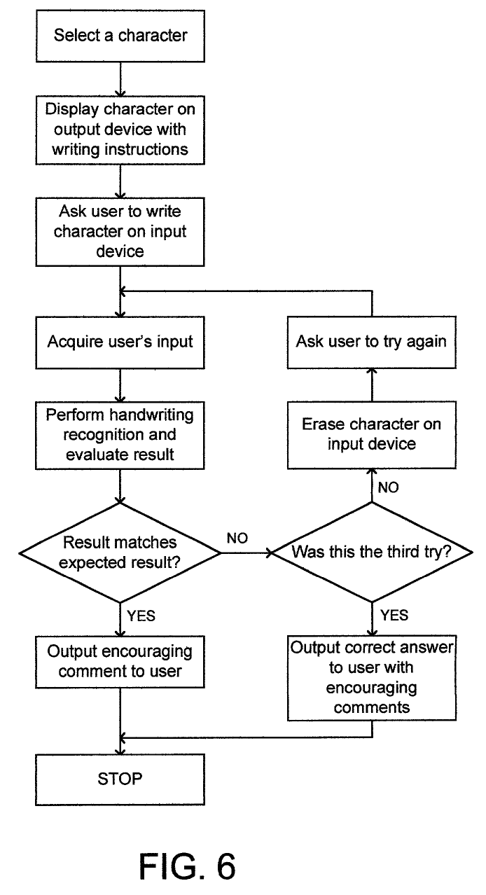

FIG. 6 is a flow chart representation of an example of the interactivity that occurs between the learning apparatus and a user. First, a character is selected on a random basis, according to the user's preference, or according to another plan that may be stored in the apparatus memory. The selected character is displayed via the output module (e.g., an output electronic screen) showing a step by step method of writing the character. This step may be accompanied by audible explanation as well as an output to the user using output speakers and employing speech synthesis techniques. The user is then asked to reproduce the shown letter by writing it on an input area that is part of the input module (e.g., an electronic tablet). The user's written response is collected and processed via non-template-based character or handwriting recognition techniques. The recognition result is then compared to an expected result, and a feedback comment is issued to the user based on this comparison. If the recognition result matches an expected result, a positive educational comment (e.g., “Great job!”) is issued to the user via the output module. If the recognition result does not match an expected result, the user is given another chance to try by erasing the written input and asking the user to try again. The user may be given a certain number of chances to try again before a correct writing method is displayed and an encouraging comment is issued to the user.

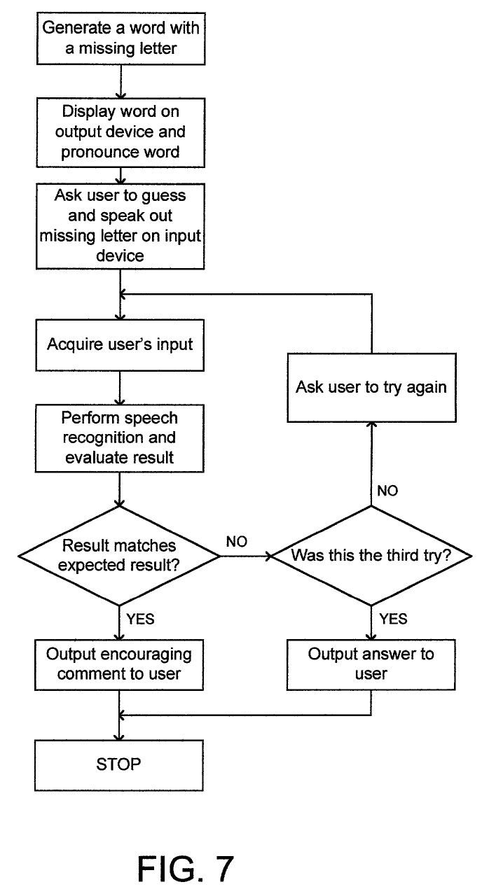

FIG. 7 is a flowchart of an example of the interactivity between the apparatus and the user for the purpose of teaching spelling of common words. A word is selected at random or according to a pre-defined plan and displayed via the output module except for one letter (a missing letter). The word is also pronounced to the user via speech synthesis through output speakers. The user is asked to speak out the missing letter into the input module means (e.g., a microphone). The spoken user's response is collected via the input module and speech recognition methods are applied to obtain a recognition result. The recognition result is compared to an expected result. If a correct match is established, a positive educational comment is issued to the user. If a correct match could not be established, the user is given another chance and is asked to try again. If upon a pre-determined number of tries a correct match could not be established, the correct result is shown by displaying the completed word in place of the word with the missing letter on the output display. Correct pronunciation of both the missing letter and the completed word is also issued to the user via output speakers and speech synthesis techniques. In another preferred embodiment the user may be asked to write down the missing letter and handwriting recognition techniques are used. In yet another preferred embodiment the user may be asked to both write and speak out the missing letter and both handwriting and speech recognition methods are used to recognize the user's input.

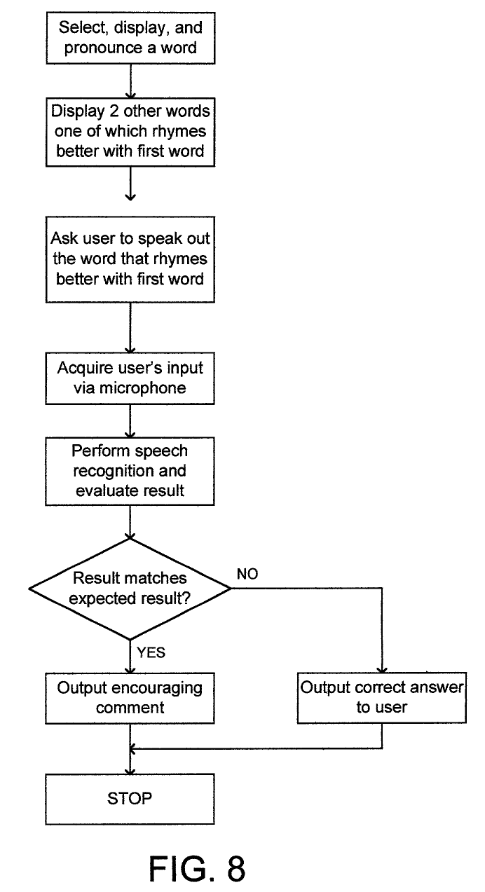

FIG. 8 is a flowchart representation of an example of the interactivity for teaching a user the concept of rhyming words. A word is displayed and read to the user, followed by displaying two other words. The user is asked to speak out the word (from among the two words) that rhymes better with the first word. The user's response is collected and processed via speech recognition techniques and a recognition result is obtained. The recognition result is compared to an expected result. If a correct match is established, a positive educational comment is issued to the user. If a correct match could not be established, the user is given the correct answer.

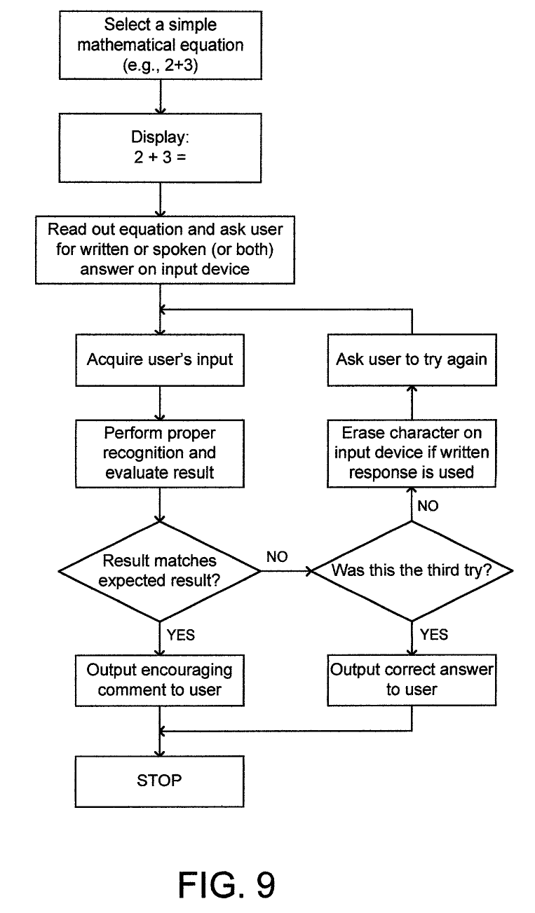

FIG. 9 is a flow chart for an example of using the interactivity of the closed loop learning apparatus to teach a child simple arithmetic operations. A simple operation is displayed (e.g., 2+3) and the user is asked about the result (e.g., “what is three plus two?”) via speech synthesis methods. The user may be given the choice to speak out the result, write down the result, or both. In any case, the user's response is collected and appropriate recognition techniques are applied to obtain a recognition result. The recognition result is compared to the expected result. If a correct match is established, a positive educational comment is issued to the user. If a correct match could not be established, the user is asked to try again and the instructions are repeated for the user. If upon a predetermined number of tries a correct match could not be established, the correct result is given to the user.

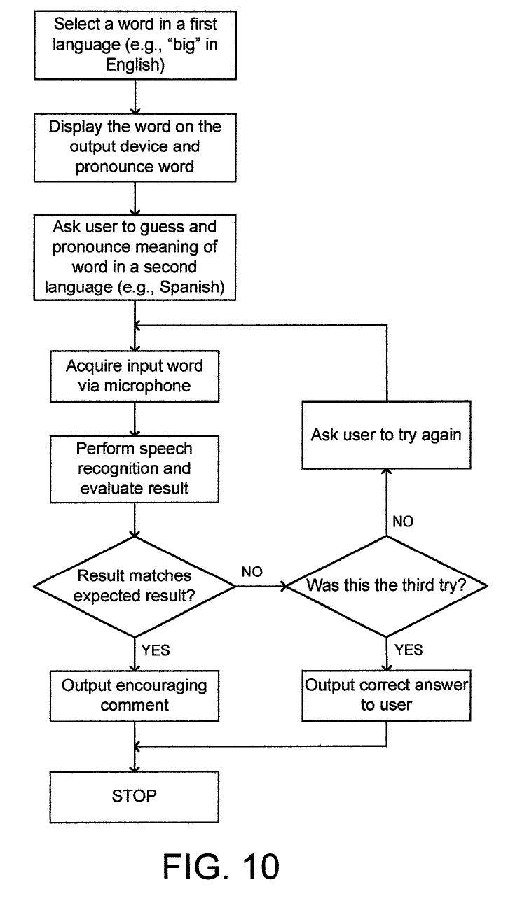

FIG. 10 is a flow chart for an example of using the interactivity of the closed loop learning apparatus to teach a child multi-lingual skills. A word is selected in a first language, displayed to the user, and pronounced using speech synthesis techniques. The user is then asked for a closest meaning of the selected word in a second language. The user's spoken response is acquired and speech recognition techniques are applied to obtain a recognition result. The recognition result is compared to the expected result. If a correct match is established, a positive educational comment is issued to the user. If a correct match could not be established, the user is asked to try again and the instructions are repeated for the user. If upon a predetermined number of tries a correct match could not be established, the correct result is output to the user.

In all of the above cases, it must me emphasized that the educational comments given to the user in cases of success or failure must all be encouraging and well suited for helping the user to learn, have fun, and build self confidence. It must also be noted that in the given examples, requesting written responses and employing handwriting recognition techniques may be either replaced or augmented, in other preferred embodiments and wherever applicable, with requesting spoken responses and employing speech recognition. Further, in the given examples, requesting spoken responses and employing speech recognition techniques may be either replaced or augmented, in other preferred embodiments and wherever applicable, with requesting written responses and employing handwriting recognition techniques.

Other preferred embodiments may include employing the closed educational loop apparatus in accordance with the present invention to teach children logical relationships (e.g., smaller than and larger than), geography concepts (e.g., names of capital cities), simple scientific facts (e.g., freezing point of water), and other educational material.

The present invention is defined by the claims given in the CLAIMS section, and nothing in this section or the previous ones should be taken as a limitation on those claims. Several variations and modifications of the described embodiments will suggest themselves to persons skilled in the related arts without departing from the inventive concepts, spirit, and scope of the present invention.

What is claimed is:

1. An interactive learning apparatus with a closed educational loop comprising:
(A) a means for communicating information or instructions, comprising questions or requests, from the apparatus to the user in at least one language.
(B) a means for obtaining a characteristic human feedback from the user to the apparatus.
(C) a means for intelligent contextual processing of said characteristic human feedback to compute an evaluation measure. Said means comprises a CPU and memory.
(D) a means for communicating educational comments, from the apparatus to the user, based on said computed measure, in at least one language.

2. An interactive learning apparatus with a closed educational loop as set forth in claim 1 wherein said means for obtaining a characteristic human feedback comprises a means for acquiring a plurality of signals pertaining to a handwritten response from the user.

3. A learning apparatus as set forth in claim 2 wherein said handwritten response comprises at least one symbol, numeral, or character, in at least one language.

4. A learning apparatus as set forth in claim 2 wherein said processing comprises non-template based character recognition module.

5. A learning apparatus as set forth in claim 2 wherein said evaluation measure comprises at least one cost function dependent upon results of recognition of said handwritten response and at least one pre-stored quantity.

6. A learning apparatus as set forth in claims 1 or 2 wherein the languages of said information, instructions, handwritten response, and educational comments are all the same.

7. A learning apparatus as set forth in claims 1 or 2 wherein the languages of said information, instructions, handwritten response, and educational comments are not all the same.

8. An interactive learning apparatus with a closed educational loop as set forth in claim 1 wherein said means for obtaining a characteristic human feedback comprises a means for acquiring a plurality of signals pertaining to a human speech response from the user.

9. A learning apparatus as set forth in claim 8 wherein said speech response comprises at least one letter, numeral, or word, in at least one language.

10. A learning apparatus as set forth in claim 8 wherein said processing comprises a speech recognition module.

11. A learning apparatus as set forth in claim 8 wherein said evaluation measure comprises at least one cost function dependent upon results of recognition of said speech response and at least one pre-stored quantity.

12. A learning apparatus as set forth in claim 8 wherein the languages of said information, instructions, handwritten response, and educational comments are all the same.

13. A learning apparatus as set forth in claim 8 wherein the languages of said information, instructions, speech response, and educational comments are not all the same.

14. A learning apparatus as set forth in claim 1, 2, or 8 wherein said means for communicating information, instructions, and educational comments comprises an electronic or a mechanical display.

15. A learning apparatus as set forth in claims 1, 2, or 8 wherein said means for communicating information, instructions, and educational comments comprises at least one speaker.

16. A learning apparatus as set forth in claims 1 or 2 wherein said means for acquiring said signals comprises an electronic tablet.

17. A learning apparatus as set forth in claims 1 or 8 wherein said means for acquiring said signals comprises at least one microphone.

18. A learning apparatus as set forth in claim 1 wherein said memory is fully contained within the apparatus.

19. A learning apparatus as set forth in claim 1 wherein said memory is a detachable memory module.

20. A learning apparatus as set forth in claim 1 wherein said means for obtaining a characteristic human feedback is proximate said apparatus.

21. A learning apparatus as set forth in claim 1 wherein said means for obtaining a characteristic human feedback is remotely connected to said apparatus.

22. An interactive learning apparatus with a closed educational loop as set forth in claim 1 wherein said means for obtaining a characteristic human feedback comprises a means for acquiring a plurality of signals pertaining to both a handwritten response and a speech response from the user.

23. A learning apparatus as set forth in claim 22 wherein said processing comprises a combined character recognition and speech recognition module.

24. A learning apparatus as set forth in claim 22 wherein said evaluation measure comprises at least one cost function dependent upon results of recognition of said handwritten response, results of recognition of said speech response, and at least one pre-stored quantity.

25. A learning apparatus as set forth in claims 1 or 22 wherein the languages of said information, instructions, handwritten response, speech response, and educational comments are all the same.

26. A learning apparatus as set forth in claims 1 or 22 wherein the languages of said information, instructions, handwritten response, speech response, and educational comments are not all the same.

27. A learning apparatus as set forth in claim 1 wherein part of said memory is used as playback memory for recording at least one interactivity transaction with the user for later review by an observer via means proximate said apparatus or via means connected to said apparatus via a wired or wireless networking schemes.

28. A wired or wireless networking scheme wherein the interactivity of at least one learning apparatus as set forth in claim 1 is monitored, influenced, or both monitored and influenced by at least one observer or instructor.
